(19) United States
(12) Patent Application Publication
(10) Pub. No.: US 2026/0290092 A1
(43) Pub. Date: Sep. 24, 2026

(54) METHOD AND SYSTEM FOR RECOGNIZING A SQUEAL NOISE OF A VEHICLE

(71) Applicants: HYUNDAI MOTOR COMPANY, Seoul (KR); KIA CORPORATION, Seoul (KR)

(72) Inventor: Sang Bum Koh, Hwaseong-si (KR)

(73) Assignees: HYUNDAI MOTOR COMPANY, Seoul (KR); KIA CORPORATION, Seoul (KR)

(21) Appl. No.: 19/273,955

(22) Filed: Jul. 18, 2025

(30) Foreign Application Priority Data
Mar. 21, 2025 (KR) 10-2025-0036436

(51) Int. Cl. G07C 5/08; H04R 3/00; H04R 19/04

(52) U.S. Cl. CPC G07C 5/0841; H04R 3/005; H04R 19/04; H04R 2201/003; H04R 2499/13

(57) ABSTRACT

A system for recognizing squeal noise in a vehicle includes a plurality of sound sensors attached to local electronic control units (ECUs) of a plurality of wheels in the vehicle. The system also includes a processor configured to store sound data received from the sound sensor in a memory at a predetermined time interval, when a squeal occurrence condition is satisfied. The processor is also configured to classify, using a first artificial intelligence model, data in which squeal noise occurs, among the sound data stored in the memory, as squeal-including data. The processor is further configured to separate a squeal chunk included in the squeal-including data, using a second artificial intelligence model. The first artificial intelligence model and the second artificial intelligence model are pre-trained using first sound data excluding the squeal noise and second sound data including the squeal noise.

### CROSS-REFERENCE TO RELATED APPLICATION(S)

This application claims benefit of and priority to Korean Patent Application No. 10-2025-0036436, filed on March 21, 2025 in the Korean Intellectual Property Office, the entire contents of which are hereby incorporated herein by reference.

### BACKGROUND

### TECHNICAL FIELD

The present disclosure relates to a system and method for recognizing a squeal noise of a vehicle. More specifically, the present disclosure relates to a system and method capable of clearly recognizing and analyzing squeal noise occurring in a vehicle equipped with an electro-mechanical brake (EMB).

### Description of Related Art

An electro-mechanical brake (EMB), also referred to as an electromechanical brake, may be a braking device in which an electric motor is coupled to a caliper or a drum brake. The EMB may be an electrified actuator operated by power and/or electrical signals, and may directly actuate a brake pad or a lining. The EMB may exhibit rapid responsiveness and may allow for more delicate control, as compared to a hydraulic brake. When applied to a hybrid or electric vehicle having a regenerative braking function, the EMB may be advantageous for cooperative control of regenerative braking, thereby improving braking feel during a blending process between regenerative braking and general braking.

Brake squeal noise may be a high-frequency abnormal mechanical noise intermittently generated from a wheel brake during braking of a vehicle, and may be mainly caused by resonance due to frictional vibration between a brake pad and a disc rotor. In addition, squeal noise may occur due to various causes, such as environmental factors including a specific temperature or humidity, driving distance, defects in components, or rust formation on the disc rotor.

Upon occurrence of squeal noise, a driver may experience discomfort and may file complaints regarding squeal noise depending on the driver's sensitivity to noise. For example, for high-end vehicles or premium brand vehicles, the expectations of drivers are generally high. Thus, even slight squeal noise may result in significant dissatisfaction from drivers.

When the frequency of complaints regarding squeal noise by drivers increases, the quality reliability of vehicles and the brand image of automobile manufacturers may be adversely affected.

The statements in this section merely provide background information related to the present disclosure and may not constitute prior art.

### SUMMARY

Aspects of the present disclosure provide a system and method for recognizing whether squeal noise occurs in a vehicle and analyzing the squeal noise accurately.

Aspects of the present disclosure provide a system and method for recognizing a squeal noise of vehicle.

Further aspects of the present disclosure provide a squeal noise recognition system including a microphone module mounted on a controller of an electro-mechanical brake (EMB) to more clearly recognize squeal noise in a vehicle equipped with the EMB, and a squeal noise recognition method.

Further aspects of the present disclosure provide a squeal noise recognition system and method capable of determining whether squeal noise occurs using an artificial intelligence model and extracting a squeal chunk.

However, the aspects of the present disclosure are not limited to those set forth herein. Other aspects not mentioned herein should be more clearly understood by those having ordinary skill in the art from the description below.

According to an aspect of the present disclosure, a system for recognizing squeal noise in a vehicle equipped with an electro-mechanical brake (EMB) system is provided. The system includes a plurality of sound sensors attached to local electronic control units (ECUs) of a plurality of wheels in the vehicle. The system also includes a processor configured to store sound data received from the sound sensor in a memory at a predetermined time interval, when a squeal occurrence condition is satisfied. The processor is also configured to classify, using a first artificial intelligence model, data in which squeal noise occurs, among the sound data stored in the memory, as squeal-including data. The processor is further configured to separate a squeal chunk included in the squeal-including data, using a second artificial intelligence model. The first artificial intelligence model and the second artificial intelligence model are pre-trained using first sound data excluding the squeal noise and second sound data including the squeal noise.

The plurality of sound sensors may include a plurality of micro electro-mechanical system (MEMS) microphones.

The plurality of sound sensors may be configured to operate by receiving power from the local ECUs.

The squeal occurrence condition may be set based on a speed of the vehicle, a hydraulic pressure of a brake of the vehicle, and whether a brake pedal is pressed.

The processor may be configured to determine whether the squeal noise occurs only when an ignition of the vehicle is in an OFF state and a remaining battery capacity of the vehicle has a preset value or more.

The first artificial intelligence model may be pre-trained, using the first sound data and data obtained by synthesizing the second sound data with the first sound data, to classify whether data input into the first artificial intelligence model is data including the squeal noise or data excluding the squeal noise.

The second artificial intelligence model may be pre-trained to output the second sound data, when the first sound data and the data obtained by synthesizing the second sound data with the first sound data are input into the second artificial intelligence model.

The processor may be configured to perform signal analysis using a fast Fourier transform (FFT) on the separated squeal chunk to extract a maximum decibel (dB) value of the squeal chunk and a frequency value of the squeal chunk at the maximum decibel value.

The processor may be configured to control the squeal analysis unit to store the maximum decibel value and the frequency value of the squeal chunk in the memory, when the maximum decibel value of the squeal chunk is greater than a preset value.

According to another aspect of the present disclosure, a method for recognizing squeal noise in a vehicle equipped with an electro-mechanical brake (EMB) system is provided. The method includes storing sound data, received from a plurality of sound sensors attached to local electronic control units (ECUs) of a plurality of wheels in the vehicle, in a memory at a predetermined time interval, when a squeal occurrence condition is satisfied. The method also includes determining whether squeal is present by classifying, using a first artificial intelligence model, data in which squeal noise occurs, among the sound data stored in the memory, as squeal-including data. The method further includes performing squeal analysis by separating a squeal chunk included in the squeal-including data, using a second artificial intelligence model. The first artificial intelligence model and the second artificial intelligence model are pre-trained using first sound data excluding the squeal noise and second sound data including the squeal noise.

The plurality of sound sensors may include a plurality of micro electro-mechanical system (MEMS) microphones.

The plurality of sound sensors may be configured to operate by receiving power from the local ECUs.

The squeal occurrence condition may be set based on a speed of the vehicle, a hydraulic pressure of a brake of the vehicle, and whether a brake pedal is pressed.

Determining whether squeal is present may include determining whether squeal is present only when an ignition of the vehicle is in an OFF state and a remaining battery capacity of the vehicle has a preset value or more.

The first artificial intelligence model may be pre-trained, using the first sound data and data obtained by synthesizing the second sound data with the first sound data, to classify whether data input into the first artificial intelligence model is data including the squeal noise or data excluding the squeal noise.

The second artificial intelligence model may be pre-trained to output the second sound data, when the first sound data and the data obtained by synthesizing the second sound data with the first sound data are input into the second artificial intelligence model.

Performing the squeal analysis may include performing signal analysis using a fast Fourier transform (FFT) on the separated squeal chunk to extract i) a maximum decibel (dB) value of the squeal chunk and ii) a frequency value of the squeal chunk at the maximum decibel value.

The method may further include storing the maximum decibel value and the frequency value of the squeal chunk in the memory, when the maximum decibel value of the squeal chunk is greater than a preset value.

According to another aspect of the present disclosure, a computer-readable medium having stored thereon executable instructions that, when executed by one or more processors, cause the one or more processors to perform a method for recognizing a squeal noise of vehicle.

The features of the present disclosure briefly summarized above are merely example aspects set forth in the following detailed description of the present disclosure, and are not intended to limit the scope of the present disclosure.

A system and method for recognizing a squeal noise of vehicle may be provided.

A squeal noise recognition system including a microphone module mounted on a controller of an EMB to more clearly recognize squeal noise in a vehicle equipped with the EMB, and a squeal noise recognition method may be provided.

A squeal noise recognition system capable of determining whether squeal noise occurs using an artificial intelligence model and extracting a squeal chunk, and a squeal noise recognition method may be provided.

However, the aspects of the present disclosure are not limited to those set forth herein. Other aspects not mentioned herein should be more easily understood by those having ordinary skill in the art from the description below.

### BRIEF DESCRIPTION OF DRAWINGS

The above and other aspects, features, and advantages of the present disclosure should be more clearly understood from the following detailed description, taken in conjunction with the accompanying drawings, in which:

FIG. 1 is a diagram illustrating an electro-mechanical brake (EMB) system of a vehicle according to an example embodiment of the present disclosure;

FIG. 2 is a diagram illustrating a configuration in which a microphone sensor is mounted in an EMB system according to an example embodiment of the present disclosure;

FIG. 3 is a diagram illustrating a squeal noise recognition system according to an example embodiment of the present disclosure;

FIGS. 4 and 5 are flowcharts illustrating a squeal noise recognition method performed by a squeal noise recognition system according to an example embodiment of the present disclosure; and

FIG. 6 is a block diagram illustrating a computing device capable of fully or partially implementing a squeal noise recognition system according to an example embodiment of the present disclosure.

### DETAILED DESCRIPTION

Hereinafter, example embodiments of the present disclosure are described in detail to enable a person having ordinary skill in the art to carry out example embodiments using the drawings. However, the present disclosure may be implemented in various different forms and is not limited to the example embodiments described herein.

In describing the example embodiments of the present disclosure, where it was determined that a detailed description of a known configuration or function would unnecessarily obscure the gist of the present disclosure, the detailed description thereof has been omitted. In the drawings, components not related to the description of the present disclosure are omitted, and similar reference numerals are used for similar components.

In the present disclosure, when it is stated that one component is “connected to,” “coupled to,” or “linked to” another component, such expressions may include not only direct connections, but also indirect connections via other one or more components therebetween. In addition, when a component is described as “comprising,” “including,” or “having” another component, unless specifically stated otherwise, the component may not exclude the presence of additional components, but rather may further include other components.

In the present disclosure, the terms such as first, second, A, B, (a), (b), and the like may be used to distinguish a component from another component. Such terms do not imply any particular order and/or importance, or others in relation to the components, unless otherwise specified herein. For example, a “first component” in one example embodiment may be referred to as a “second component” in another example embodiment, and vice versa.

In the present disclosure, mutually distinct components may be used to clearly describe respective characteristics. However, such separation does not necessarily imply that the components are physically separated from each other. For example, a plurality of components may be integrated into a single hardware or software unit, or a single component may be distributed across a plurality of hardware or software units. Accordingly, integrated or distributed example embodiments, even if not explicitly stated, are also included within the scope of the present disclosure.

In the present disclosure, components described in various example embodiments do not necessarily indicate essential components, and some components may be optional components. Accordingly, an example embodiment including a subset of the components described in one example embodiment may also be included within the scope of the present disclosure. In addition, an example embodiment including additional components in addition to the components described in various example embodiments is also included within the scope of the present disclosure.

In the present disclosure, when a component, controller, device, element, unit, apparatus, or the like of the present disclosure is described as having a purpose or performing an operation, function, or the like, the component, controller, device, element, unit, apparatus, or the like should be considered herein as being “configured to” meet that purpose or to perform that operation or function. Each component, controller, device, element, unit, apparatus, and the like may separately embody or be included with a processor and a memory, such as a non-transitory computer readable media, as part of the apparatus.

Hereinafter, a system and method for recognizing a squeal noise of a vehicle according to example embodiments of the present disclosure are described with reference to the accompanying drawings.

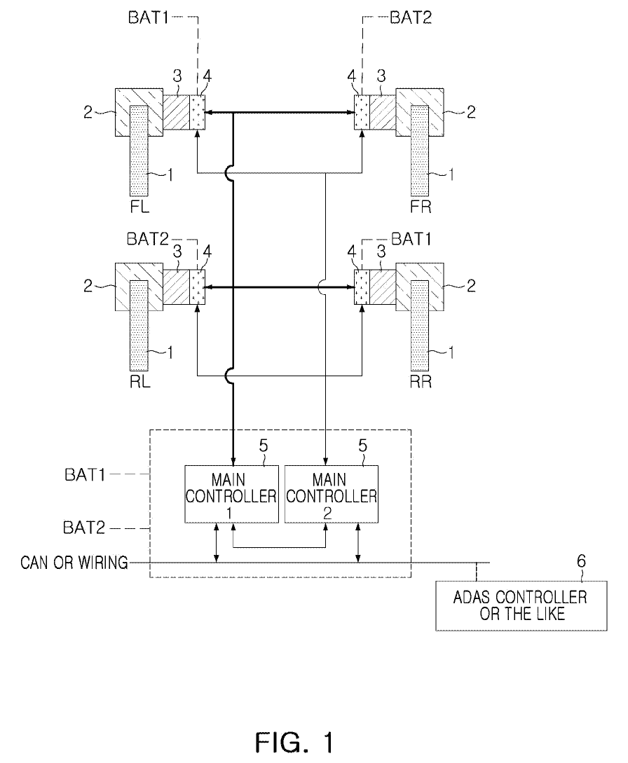

FIG. 1 is a diagram illustrating an electro-mechanical brake (EMB) system of a vehicle according to an example embodiment of the present disclosure.

An EMB, also referred to as an electromechanical brake, may be a braking device in which an electric motor is coupled to a caliper or a drum brake. The EMB may be an electrified actuator operated by power and/or electrical signals, and may directly actuate a brake pad or a lining. The EMB may exhibit rapid responsiveness and may allow for more delicate control compared to a hydraulic brake. When applied to a hybrid or electric vehicle having a regenerative braking function, the EMB may be advantageous for cooperative control of regenerative braking, thereby improving braking feel during a blending process between regenerative braking and general braking. In addition, various components, such as a booster, a tube, and the like, may be unnecessary in the EMB system, and thus the vehicle may have improved design freedom.

Referring to FIG. 1, an EMB system of a vehicle according to an example embodiment of the present disclosure is illustrated. In general, a vehicle may have a four-wheel system, and an EMB may be configured at each of four corners (Front Left - FL, Front Right - FR, Rear Left - RL, and Rear Right - RR). However, the EMB system illustrated in FIG. 1 is merely an example and the present disclosure is not limited thereto.

Each wheel of the vehicle may include a brake disc 1, a brake caliper 2, a motor actuator 3, and a local electronic control unit (ECU) 4. As illustrated in FIG. 1, the motor actuator 3 and the local ECU 4 may be attached to the brake caliper 2. To provide redundancy, two main controllers (main ECUs) 5 and two power supplies BAT 1 and BAT 2 may be applied, respectively.

In addition, considering power failure, a power supply connection may be configured in an X form or H-split form. In FIG. 1, a configuration connected in the X form is illustrated, and a configuration is illustrated in which i) FL and RR wheels are connected to power supply 1 BAT 1 and ii) FR and RL wheels are connected to power supply 2 BAT 2.

In an example, one or more (e.g., two) main controllers 5 (collectively referred to herein as “main controller”) may be provided. Communication between the main controller 5 and the local ECU 4 may be performed using various methods such as CAN, FlexRay, or hard wiring.

In addition, the main controller 5 illustrated in FIG. 1 may receive various signals, such as a brake pedal stroke amount and wheel speed, using CAN and/or wiring, and may control various braking operations. In an example, the controllers 5 may also control an advanced driver assistance system (ADAS) controller 6.

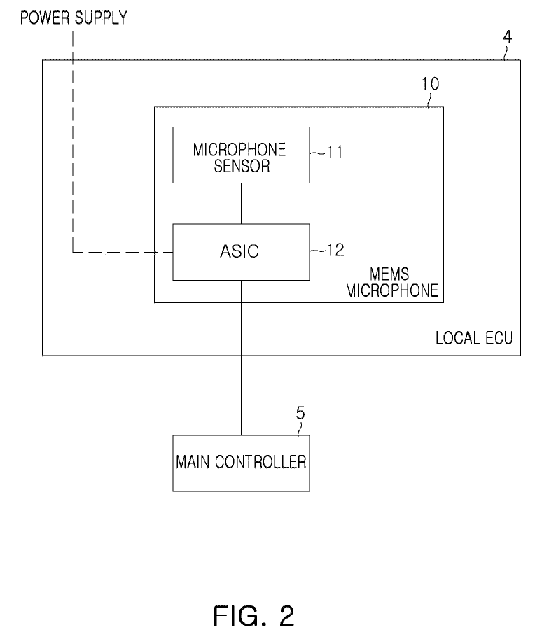

For squeal noise recognition in a squeal noise recognition system according to an example embodiment of the present disclosure, a microphone sensor 11 may be mounted in the local ECU 4. Such a configuration, according to an embodiment, is described in more detail below with reference to FIG. 2.

FIG. 2 is a diagram illustrating a configuration in which a microphone sensor is mounted in an EMB system according to an example embodiment of the present disclosure.

Referring to FIG. 2, a micro electro-mechanical system (MEMS)-type microphone 10 may be mounted in a local ECU 4 included in an EMB system of each of wheels of the vehicle illustrated in FIG. 1.

The MEMS-type microphone 10 may include a microphone sensor 11 and an application-specific integrated circuit (ASIC) 12.

The MEMS microphone 10 may be a type of ultra-small microphone manufactured using microfabrication technology. The MEMS microphone 10 may have a significantly small size and low power consumption. The MEMS microphone 10 may generally be classified into an analog-type MEMS microphone and a digital-type MEMS microphone.

The analog-type MEMS microphone 10, when sound reaches a fine diaphragm of the microphone, may cause the diaphragm to move due to a pressure change caused by the sound, and the movement of the diaphragm may be converted into an analog electrical signal through a conversion mechanism in the microphone. The converted electrical signal may be transmitted to an amplifier, an analog filter, or another device receiving an analog input. In general, the analog-type microphone may have low power consumption, but may be vulnerable to noise.

The digital type MEMS microphone 10 may sense sound pressure in a manner similar to the analog-type MEMS microphone 10, but may convert the sensed sound pressure into a digital signal through an analog-to-digital converter (ADC) therein. The converted digital signal may be processed in the form of a digital data stream by a digital signal processor (DSP) or another digital system. In general, a digital-type microphone may have higher power consumption as compared to an analog-type microphone. However, the digital-type microphone may have high resistance to noise and various functions in addition to sound detection.

The MEMS microphone 10 illustrated in FIG. 2 may be the digital-type MEMS microphone 10. When implemented as the analog-type MEMS microphone 10, an analog-to-digital converter (ADC) may be additionally configured in the local ECU 4.

The microphone sensor 11 may be mounted in the local ECU 4 of each wheel and may perform a function of collecting ambient sound. The ASIC 12 may apply a bias to the microphone sensor 11 and may perform detection and amplification of a sound signal.

As illustrated in FIG. 2, the MEMS microphone 10 may be controlled by the main controller 5. Power to the MEMS microphone 10 may be indirectly supplied from the local ECU 4. Alternatively, according to another example embodiment, power may be directly supplied to the MEMS microphone 10.

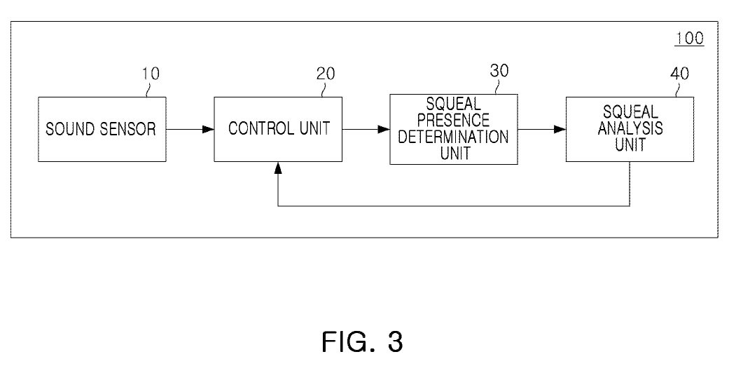

FIG. 3 is a diagram illustrating a squeal noise recognition system according to an example embodiment of the present disclosure.

Referring to FIG. 3, according to an example embodiment, a squeal noise recognition system 100 may include a sound sensor 10, a control unit 20, a squeal presence determination unit 30, and a squeal analysis unit 40. However, the system is not limited thereto. For example, the system may further include additional components not illustrated in FIG. 3.

The sound sensor 10 may be a MEMS-type microphone attached to a local ECU 4 of each of a plurality of wheels of a vehicle, as described with reference to FIG. 2. For example, the sound sensor 10 may be attached to an EMB system and may perform a function of recognizing various sounds (including squeal noise) in a surrounding environment of the vehicle in real time. According to an example embodiment, the sound sensor 10 may operate by receiving power directly or indirectly from the local ECU 4.

A control unit 20 may store sound data received from the sound sensor 10 in a memory at a predetermined time interval when a squeal occurrence condition is satisfied. For example, the control unit 20 may have a configuration the same as that of the main controller 5 described above or may be included in the main controller 5. Alternatively, the control unit 20 may be implemented as a separate component from the main controller 5. The memory may be included in or separate from the main controller 5. The memory may be an electrically erasable programmable read-only memory (EEPROM), which is one type of non-volatile memory, but the present disclosure is not limited thereto.

The squeal occurrence condition may be a condition in which squeal noise easily occurs. The squeal occurrence condition may be separately set for each vehicle during development. The squeal occurrence condition may be set based on a vehicle speed, a vehicle brake hydraulic pressure, and whether a brake pedal is in an ON state or OFF state (whether the brake pedal is pressed). For example, a condition in which the brake pedal is in an ON state (pressed), the vehicle speed is less than a predetermined speed, and the brake pad hydraulic pressure is less than a predetermined pressure may be set as the squeal occurrence condition. In such a case, only when the condition is satisfied, an operation of storing the sound data received from the sound sensor 10 in the memory at a predetermined time interval may be performed.

The squeal presence determination unit 30 may classify, using a pre-trained first artificial intelligence model, i) data in which squeal noise occurs, among the sound data stored in the memory, as squeal-including data and ii) data in which squeal noise does not occur, among the sound data stored in the memory, as squeal-excluding data.

In determining whether the squeal noise occurs through the classification, the squeal presence determination unit 30 may perform the determination only when an ignition of the vehicle is in an OFF state and a remaining battery capacity of the vehicle has a preset value or more. The preset value of the remaining battery capacity may be set differently depending on a user of the system.

The first artificial intelligence model used by the squeal presence determination unit 30 may be a machine learning model used to classify whether squeal occurs. The first artificial intelligence model may be a model that is pre-trained using first sound data excluding squeal noise and second sound data including squeal noise.

In order to train the first artificial intelligence model, the following processes may be performed.

During vehicle development evaluation, pieces of sound data may be collected for each unit time period (for example, every 10 seconds) using a MEMS microphone of each EMB system in various driving and braking modes. Various ambient noises and abnormal mechanical sounds may be recorded together. However, sound data excluding squeal noise may be collected. Such data collection may be performed for each of four wheels of the vehicle.

In addition, during development and evaluation of a wheel brake under a bench condition in an anechoic chamber, only pieces of data corresponding to squeal noise may be collected through a MEMS microphone of an EMB in bench evaluation driving and braking modes. The data corresponding to squeal noise may be single-shot data from a start to an end of squeal, rather than data collected for each unit time period. Such data collection may also be performed for each of four wheels of the vehicle.

In addition, for training the artificial intelligence model, a process of synthesizing the data corresponding to squeal noise with the data excluding squeal noise may be performed, and in some examples, sound data augmentation may be performed. Various known techniques may be used for sound data augmentation, and are not limited to specific examples.

For example, for sound data augmentation, a technique of randomly adjusting a volume of each of the data excluding squeal noise and the data corresponding to squeal noise, or a volume of data obtained by synthesizing the data excluding squeal noise and the data corresponding to squeal noise, may be used. A frequency masking technique may also be used. As another example, a technique of synthesizing data by advancing or delaying a synthesis position of the data corresponding to squeal noise for the data excluding squeal noise at a predetermined interval (for example, 10 seconds) may be used.

When a sound data augmentation process is performed as described above, even when a quantity of pieces of data excluding squeal noise and a quantity of pieces of data corresponding to squeal noise are both small, a large quantity of training data may be generated.

In the present disclosure, first sound data excluding squeal noise may refer to the data excluding squeal noise as described above, and second sound data including squeal noise may refer to data obtained by synthesizing the data excluding squeal noise with the data corresponding to squeal noise.

The first sound data and the second sound data generated through the above process may be used to train the first artificial intelligence model. For example, when the first sound data or the second sound data is input as input data to the first artificial intelligence model, training may be performed such that the first artificial intelligence model outputs data classified as one of the first sound data and the second sound data.

The first artificial intelligence model may be any classification machine learning model capable of classifying input data, and is not limited to specific examples. In addition, the first artificial intelligence model may be continuously updated through ongoing learning.

The squeal analysis unit 40 may perform a function of separating a squeal chunk value included in squeal-including data, classified by the squeal presence determination unit 30 as data including squeal noise, using a pre-trained second artificial intelligence model. The squeal chunk may refer to the data corresponding to squeal noise.

The second artificial intelligence model used by the squeal analysis unit 40 may be an artificial intelligence model classifying sound data corresponding to squeal noise (squeal chunk) and sound data not including squeal noise from the input squeal-including data. In the same manner as the first artificial intelligence model, the second artificial intelligence model may be a model that is pre-trained using the first sound data excluding squeal noise and the second sound data including squeal noise.

In an example, training of the second artificial intelligence model may be performed such that, when the first sound data and the second sound data are input as input values, only data corresponding to the squeal chunk is output from the second sound data.

The second artificial intelligence model may be any artificial intelligence model performing the input and output functions described above. For example, the second artificial intelligence model may be a deep learning model such as a recurrent neural network (RNN) that is effective for processing time-series data, but the present disclosure is not limited thereto.

In addition, the squeal analysis unit 40 may perform signal analysis on the separated squeal chunk in addition to the above-described function of separating the squeal chunk. For example, the squeal analysis unit 40 may perform signal analysis using a fast Fourier transform (FFT) on the separated squeal chunk to extract a maximum decibel (dB) value of the squeal chunk and a frequency value of the squeal chunk at the maximum decibel value. Various techniques in addition to the FFT may be used for the signal analysis.

The control unit 20 may control the memory to store the maximum decibel value and the frequency value of the squeal chunk at the maximum decibel value when the maximum decibel value analyzed by the squeal analysis unit 40 meets a preset criterion (e.g., is greater than a preset value).

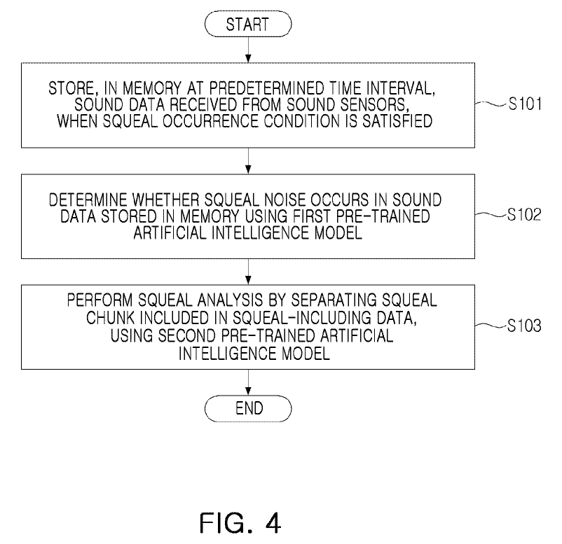

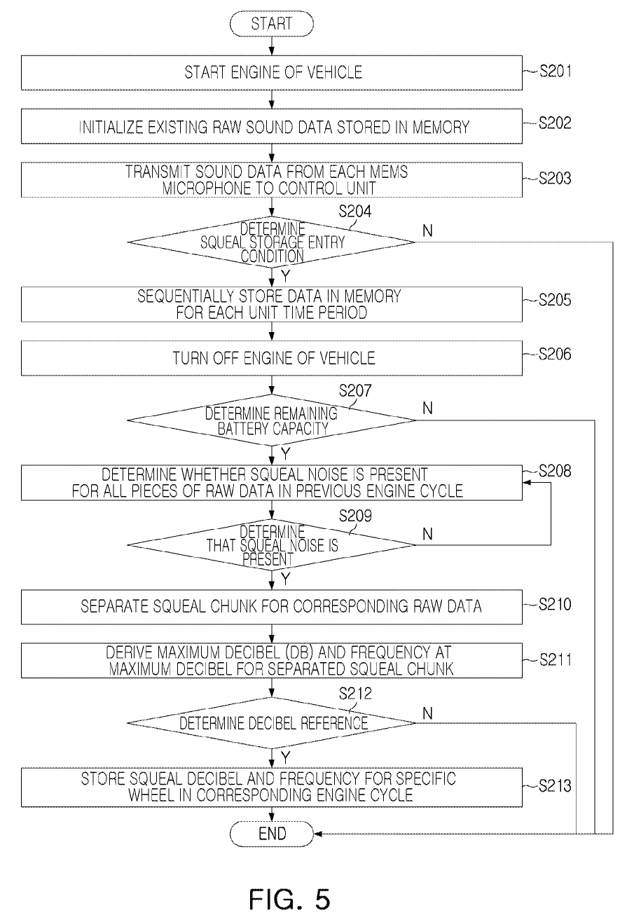

FIGS. 4 and 5 are flowcharts illustrating a squeal noise recognition method performed by a squeal noise recognition system according to an example embodiment of the present disclosure.

The squeal noise recognition method illustrated in FIGS. 4 and 5 may be performed by the squeal noise recognition system 100 described above, and the above-described descriptions may be equally applied to FIGS. 4 and 5.

Referring to FIG. 4, in a method of recognizing squeal noise in a vehicle equipped with an EMB system, when a squeal occurrence condition is satisfied, an operation S101 of storing, in a memory at a predetermined time interval, sound data received from a plurality of sound sensors 10 attached to local ECUs 4 of a plurality of wheels in the vehicle may be performed.

For example, the sound sensor 10 may be a MEMS-type microphone. The sound sensor 10 may operate by receiving power from the local ECUs 4.

In an example, the squeal occurrence condition may be set based on a speed of the vehicle, a hydraulic pressure of a brake of the vehicle, and whether a brake pedal is pressed.

In an operation S102, the squeal noise recognition system 100 may determine whether squeal is present by classifying, using a first pre-trained artificial intelligence model, data in which squeal noise occurs in the sound data 10 stored in the memory as squeal-including data. In an example, operation S102 may be performed only when an ignition of the vehicle is in an OFF state and a remaining battery capacity of the vehicle has a preset value or more.

The first artificial intelligence model may be a model that is pre-trained using first sound data excluding squeal noise and second sound data including the squeal noise. The first artificial intelligence model may be pre-trained to classify whether data input into the first artificial intelligence model is data including the squeal noise or data excluding the squeal noise, using the first sound data and data obtained by synthesizing the second sound data with the first sound data.

In an operation S103, the squeal noise recognition system 100 may perform squeal analysis by separating a squeal chunk included in the squeal-including data, using a second pre-trained artificial intelligence model.

The second artificial intelligence model may be a model that is pre-trained using first sound data excluding the squeal noise and second sound data including the squeal noise. The second artificial intelligence model may be pre-trained to output the second sound data, when the first sound data and data obtained by synthesizing the second sound data with the first sound data are input into the second artificial intelligence model.

In an example, the operation S103 may include an operation of performing signal analysis using a fast Fourier transform (FFT) on the separated squeal chunk to extract a maximum decibel (dB) value of the squeal chunk and a frequency value of the squeal chunk at the maximum decibel value.

In addition, a squeal noise recognition system 100 according to an example embodiment of the present disclosure may store the maximum decibel value and the frequency value of the squeal chunk in the memory when the maximum decibel value of the squeal chunk is greater than a preset value.

In an example, the squeal noise recognition system 100 according to an example embodiment of the present disclosure may store the maximum decibel value and the frequency value of the squeal chunk in the memory when the maximum decibel value of the squeal chunk is greater than a preset value. For example, the preset value may be a value set during vehicle development. The preset value may be, for example, a reference value set based on a case in which the squeal noise occurs at a level disturbing to a vehicle driver.

Referring to FIG. 5, a method of recognizing squeal noise by a squeal noise recognition system 100 according to an example embodiment of the present disclosure is illustrated in more detail.

When an engine of a vehicle is started in an operation S201, initialization of existing raw sound data stored in a memory may be performed in an operation S202. In an operation S203, sound data from each MEMS microphone may be transmitted to a control unit 20.

In an operation S204, a squeal storage entry condition may be determined. The operation S204 may be an operation of determining the squeal occurrence condition described above. In an example, the operation S204 may determine whether a reference set based on whether a brake pedal is pressed, a vehicle speed, and a brake hydraulic pressure is satisfied.

When it is determined in the operation S204 that the storage entry condition is satisfied (Yes (Y) in the operation S204), the sound data transmitted in the operation S203 may be stored in the memory for each unit time period in an operation S205. It may be determined whether squeal noise has occurred for pieces of the stored data. When it is determined in operation S204 that the storage entry condition is not satisfied (No (N) in the operation S204), squeal noise recognition may not be performed.

After operation S205 is performed, the engine of the vehicle may be turned off in an operation S206. Once the engine is turned off, a remaining battery capacity of the vehicle may be determined in an operation S207, and whether the remaining battery capacity has a preset value or more may be determined. When it is determined that the remaining battery capacity is not sufficient (No (N) in the operation S207), squeal noise recognition may not be performed.

On the other hand, when it is determined that the remaining battery capacity is sufficient (Yes (Y) in the operation S207), determination of whether squeal noise is present may be performed for pieces of raw data (e.g., for all pieces of raw data) in a previous engine cycle in an operation S208. The operation S208 may be performed by the squeal presence determination unit 30 described above. When the squeal presence determination unit 30 determines that squeal noise is present (Yes (Y) in the operation S209), separation of a squeal chunk for corresponding raw sound data may be performed by a squeal analysis unit 40 in an operation S210, and a maximum decibel (dB) value and a frequency value at the maximum decibel value may be derived for the separated squeal chunk in an operation S211.

In an operation S212, it may be determined whether the derived maximum decibel value is greater than a preset reference value. When it is determined that the derived maximum decibel value is greater than the preset reference value (Yes (Y) in the operation S212), a squeal decibel and a frequency for a specific wheel in a corresponding engine cycle may be stored in the memory in an operation S213. For example, the preset reference value may be a value set during a vehicle development operation. The preset reference value may, for example, refer to a decibel value of squeal noise disturbing to a driver.

Operations S208 to S213 may be repeatedly performed for pieces of raw sound data (e.g., for all pieces of raw sound data) collected during a plurality of previous ignition cycles.

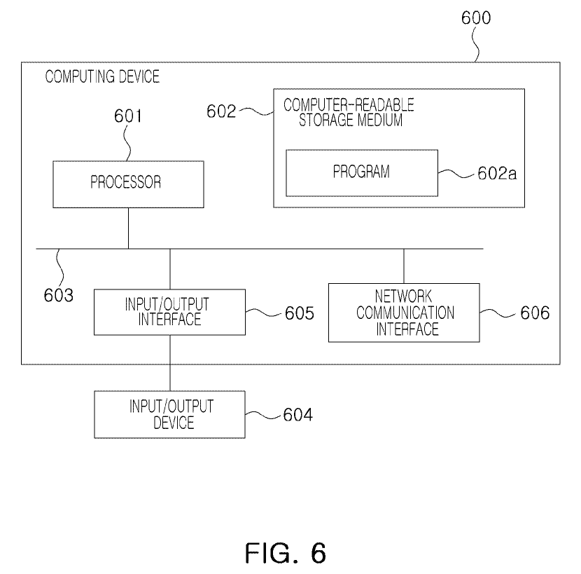

FIG. 6 is a block diagram illustrating a computing device capable of fully or partially implementing a squeal noise recognition system according to an example embodiment of the present disclosure.

FIG. 6 is a block diagram illustrating a computing device 600 capable of fully or partially implementing a squeal noise recognition system 100 according to an example embodiment of the present disclosure. The computing system 600 may include or implement all or part of the squeal noise recognition system 100 illustrated in FIG. 3.

As illustrated in FIG. 6, the computing device 600 may include at least one processor 601, a computer-readable storage medium 602, and a communication bus 603.

In one example, the processor 601 may cause the computing device 600 to operate according to the example embodiments described above. For example, the processor 601 may execute one or more programs stored in the computer-readable storage medium 602. The one or more programs may include one or more computer-executable instructions. When executed by the processor 601, the one or more computer-executable instructions may be configured to cause the computing device 600 to perform operations according to example embodiments. In another example, the processor 601 of the computing device 600 of FIG. 6 may be capable of implementing the functions of the different units of the squeal noise recognition system 100 of FIG. 3, or causing the different units to perform their respective functions.

The computer-readable storage medium 602 may be configured to store the computer-executable instructions or program code, program data, and/or other suitable forms of information. A program 602a, stored in the computer-readable storage medium 602, may include a set of instructions executable by the processor 601. In an example embodiment, the computer-readable storage medium 602 may be a memory (a volatile memory such as a random access memory, a non-volatile memory, or any suitable combination thereof), one or more magnetic disk storage devices, optical disk storage devices, flash memory devices, other types of storage media that are accessible by the computing device 600 and are capable of storing desired information, or any suitable combinations thereof.

The communication bus 603 may interconnect various other components of the computing device 600, including the processor 601 and the computer-readable storage medium 602.

The computing device 600 may also include one or more input/output interfaces 605 providing an interface for one or more input/output devices 604, and one or more network communication interfaces 606. The input/output interface 605 and the network communication interface 606 may be connected to the communication bus 603.

The network communication interface 606 may be an interface for in-vehicle communication or an interface for communication between a vehicle and a device other than the vehicle, and may include, for example, a controller area network (CAN), a media oriented systems transport (MOST) network, a local interconnect network (LIN), and/or X-by-Wire (Flexray), Wi-Fi, Bluetooth, NFC, or RFID. A network may be one of a cellular network, for example, a global system for mobile communications (GSM), an enhanced data rate for GSM evolution (EDGE), a general packet radio service (GPRS), a code division multiple access (CDMA), a time division-CDMA (TD-CDMA), a universal mobile telecommunications system (UMTS), or long-term evolution (LTE), or another cellular network.

The input/output device 604 may be connected to other components of the computing device 600 through the input/output interface 605. The input/output device 604 may include a pointing device (such as a mouse or trackpad), a keyboard, a touch input device (such as a touchpad or touchscreen), a voice or sound input device, input devices such as various types of sensor devices and/or photographing devices, and/or output devices such as a display device, a printer, a speaker, and/or a network card. The input/output device 604 may be included in the computing device 600 as a component included in the computing device 600 or may be connected to the computing device 600 as a device, distinct from the computing device 600.

Example methods of the present disclosure are described herein as a series of operations for clarity of description; however, the order of operations is not intended to be limiting. Respective operations may be performed simultaneously or in a different order, if necessary. In order to implement the method according to embodiments of the present disclosure, additional operations may be included in addition to the described operations, some described operations may be excluded, or some operations may be excluded and other additional operations may be included.

Various described example embodiments of the present disclosure are not intended to list all possible combinations, but are intended to describe representative aspects of the present disclosure. The features described in the various example embodiments may be applied independently or in combination of two or more.

In addition, the various example embodiments of the present disclosure may be implemented in hardware, firmware, software, or a combination thereof. In the case of hardware implementation, the example embodiments may be implemented using one or more application-specific integrated circuits (ASICs), digital signal processors (DSPs), digital signal processing devices (DSPDs), programmable logic devices (PLDs), field-programmable gate arrays (FPGAs), general processors, controllers, microcontrollers, or microprocessors.

The scope of the present disclosure includes software or machine-executable instructions (for example, operating systems, applications, firmware, programs) that cause operations according to methods of the various example embodiments to be executed on a device or computer, and non-transitory computer-readable media in which the software or instructions are stored and which are executable on a device or computer.

While example embodiments have been shown and described above, it should be apparent to those having ordinary skill in the art that modifications and variations could be made without departing from the scope of the present disclosure as defined by the appended claims.

What is claimed is:

1. A system for recognizing squeal noise in a vehicle equipped with an electro-mechanical brake (EMB) system, the system comprising:
a plurality of sound sensors attached to local electronic control units (ECUs) of a plurality of wheels in the vehicle; and
a processor configured to
store sound data received from the sound sensor in a memory at a predetermined time interval, when a squeal occurrence condition is satisfied,
classify, using a first artificial intelligence model, data in which squeal noise occurs, among the sound data stored in the memory, as squeal-including data, and
separate a squeal chunk included in the squeal-including data, using a second artificial intelligence model,
wherein the first artificial intelligence model and the second artificial intelligence model are pre-trained using first sound data excluding the squeal noise and second sound data including the squeal noise.

2. The system of claim 1, wherein the plurality of sound sensors includes a plurality of micro electro-mechanical system (MEMS) microphones.

3. The system of claim 1, wherein the plurality of sound sensors is configured to operate by receiving power from the local ECUs.

4. The system of claim 1, wherein the squeal occurrence condition is set based on a speed of the vehicle, a hydraulic pressure of a brake of the vehicle, and whether a brake pedal is pressed.

5. The system of claim 1, wherein the processor is configured to determine whether the squeal noise occurs only when an ignition of the vehicle is in an OFF state and a remaining battery capacity of the vehicle has a preset value or more.

6. The system of claim 1, wherein the first artificial intelligence model is pre-trained, using the first sound data and data obtained by synthesizing the second sound data with the first sound data, to classify whether data input into the first artificial intelligence model is data including the squeal noise or data excluding the squeal noise.

7. The system of claim 1, wherein the second artificial intelligence model is pre-trained to output the second sound data, when the first sound data and the data obtained by synthesizing the second sound data with the first sound data are input into the second artificial intelligence model.

8. The system of claim 1, wherein the processor is configured to perform signal analysis using a fast Fourier transform (FFT) on the separated squeal chunk to extract i) a maximum decibel (dB) value of the squeal chunk and ii) a frequency value of the squeal chunk at the maximum decibel value.

9. The system of claim 8, wherein the processor is configured to store the maximum decibel value and the frequency value of the squeal chunk in the memory, when the maximum decibel value of the squeal chunk is greater than a preset value.

10. A method for recognizing squeal noise in a vehicle equipped with an electro-mechanical brake (EMB) system, the method comprising:
storing sound data, received from a plurality of sound sensors attached to local electronic control units (ECUs) of a plurality of wheels in the vehicle, in a memory at a predetermined time interval, when a squeal occurrence condition is satisfied;
determining whether squeal is present by classifying, using a first artificial intelligence model, data in which squeal noise occurs, among the sound data stored in the memory, as squeal-including data; and
performing squeal analysis by separating a squeal chunk included in the squeal-including data, using a second artificial intelligence model,
wherein the first artificial intelligence model and the second artificial intelligence model are pre-trained using first sound data excluding the squeal noise and second sound data including the squeal noise.

11. The method of claim 10, wherein the plurality of sound sensors includes a plurality of micro electro-mechanical system (MEMS) microphones.

12. The method of claim 10, wherein the plurality of sound sensors operates by receiving power from the local ECUs.

13. The method of claim 10, wherein the squeal occurrence condition is set based on a speed of the vehicle, a hydraulic pressure of a brake of the vehicle, and whether a brake pedal is pressed.

14. The method of claim 10, wherein determining whether squeal is present includes determining whether squeal is present only when an ignition of the vehicle is in an OFF state and a remaining battery capacity of the vehicle has a preset value or more.

15. The method of claim 10, wherein the first artificial intelligence model is pre-trained, using the first sound data and data obtained by synthesizing the second sound data with the first sound data, to classify whether data input into the first artificial intelligence model is data including the squeal noise or data excluding the squeal noise.

16. The method of claim 10, wherein the second artificial intelligence model is pre-trained to output the second sound data, when the first sound data and the data obtained by synthesizing the second sound data with the first sound data are input into the second artificial intelligence model.

17. The method of claim 10, wherein performing the squeal analysis includes performing signal analysis using a fast Fourier transform (FFT) on the separated squeal chunk to extract i) a maximum decibel (dB) value of the squeal chunk and ii) a frequency value of the squeal chunk at the maximum decibel value.

18. The method of claim 17, further comprising storing the maximum decibel value and the frequency value of the squeal chunk in the memory, when the maximum decibel value of the squeal chunk is greater than a preset value.
